(19) United States
(12) Patent Application Publication
(10) Pub. No.: US 2025/0278606 A1
(43) Pub. Date: Sep. 4, 2025

(54) PHYSICS COMPUTING PROCESSOR SUPPORTING PHYSICS-INFORMED NEURAL NETWORKS AND FINITE ELEMENT METHODS FOR SCIENTIFIC COMPUTING

(71) Applicant: Northwestern University, Evanston, IL (US)

(72) Inventors: Jie Gu, Evanston, IL (US); Yuhao Ju, Evanston, IL (US)

(21) Appl. No.: 19/051,369

(22) Filed: Feb. 12, 2025

Related U.S. Application Data
(60) Provisional application No. 63/552,408, filed on Feb. 12, 2024.

(51) Int. Cl. G06N 3/042

(52) U.S. Cl. CPC G06N 3/042

(57) ABSTRACT

In an aspect, a physics computing unit (PhyCU) on an application-specific integrated circuit (ASIC) includes top general purpose SRAM banks in communication with a physics processing element (PHY-E) array. Bottom general purpose SRAM banks are in communication with the PHY-E array. Input SRAM banks are in communication with the PHY-E array, wherein the input SRAM banks are configured to store input data. A special parameters SRAM bank is in communication with the PHY-E array. An input mesh data compression module (IDCM) is in communication with the input SRAM banks and the PHY-E array, wherein the PHY-E is reconfigurable to operate in a physics-informed neural network (PINN) modes and a finite element method (FEM) mode. An offset-based sparsity address scheduler (OBSAS) is configured to compress the input data for sparse matrix-vector (SpMV) multiplication in the PINN modes and for conjugate gradient (CG) iterative method in the FEM mode.

### CROSS-REFERENCE TO RELATED APPLICATION

The present application claims the benefit of priority under 35 U.S.C. § 119 from U.S. Provisional Patent Application Ser. No. 63/552,408 entitled “Physics Computing Processor Supporting Physics-Informed Neural Networks and Finite Element Methods for Scientific Computing,” filed on Feb. 12, 2024, the disclosure of which is hereby incorporated by reference in its entirety for all purposes.

### STATEMENT OF FEDERALLY FUNDED RESEARCH OR SPONSORSHIP

This invention was made with government support under grant number CCF-2008906 awarded by the National Science Foundation. The government has certain rights in the invention.

### TECHNICAL FIELD

The present disclosure generally relates to physics computing processors, and more specifically relates to physics computing processor supporting physics-informed neural networks and finite element methods for scientific computing.

### BACKGROUND

The demand for real-time computing on edge devices from emerging applications, e.g. AI, has exploded in recent years. Lately, physics-based scientific computing has also drawn significant interests driven by the growth of real-time applications, e.g., VR, IoT, robotics, etc. Some examples of real-time physics-based computation are structural deformation in photorealistic VR/MR, robot dynamic control, temperature monitoring in additive manufacturing, and real-time leak-gas tracking. Unfortunately, hardware support for numerical scientific computing on edge devices is relatively poor, hindering the use of high-accuracy, high-resolution physics-based computing in real time. An example is beam deformation analysis in VR/MR falling short of a real-time latency target using solvers due to the large number of iterations for convergence. Recently, ASIC solvers have been designed to solve Poisson equation-related applications with a finite difference method (FDM), but have trouble handling more complex structures. To overcome the real-time hurdle, physics-informed neural network (PINN) or physics-informed machine learning (PIML) solutions are being developed by the scientific community, using a data-driven approach to boost the computing efficiency of physics solvers. PINN solutions can reach 1900-10000× speedup compared with solvers based on Nvidia Modulus with less than 1% accuracy loss. However, if numerous physics equations are to be processed by a PINN, highly diversified dataflows are needed to support a variety of PINN models, making it unfriendly to an ASIC solution. In addition, a tradeoff of speed and accuracy needs to be made between a PINN and classic numerical solutions for a specific application.

The description provided in the background section should not be assumed to be prior art merely because it is mentioned in or associated with the background section. The background section may include information that describes one or more aspects of the subject technology.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 schematically illustrates a top-level chip architecture of an unified physics computing unit (PhyCU) with sparsity, data compression, and dataflow features, according to certain aspects of the present disclosure.

FIG. 2 schematically illustrates a physics processing element (PHY-E) of the PhyCU of FIG. 1, according to certain aspects of the present disclosure.

FIG. 3 schematically illustrates a physics-informed neural network (PINN) algorithm which can be performed on the PhyCU of FIG. 1, according to certain aspects of the present disclosure.

FIG. 4 schematically illustrates a finite element method (FEM) using conjugate gradient (CG) iterative method which can be performed on the PhyCU of FIG. 1, according to certain aspects of the present disclosure.

FIG. 5 is a chart illustrating examples of configurable dataflows optimized for PINN supporting diversified models, according to certain aspects of the present disclosure.

FIG. 6 schematically illustrates an example discrete Fourier transform (DFT) dataflow in Fourier Neural Operation (FNO) for supported PINN neural operators, according to certain aspects of the present disclosure. A schematic comparison is illustrated comparing original DFT with DFT optimization, according to certain aspects of the present disclosure.

FIG. 7 schematically illustrates an example programmable Sin/Cos dataflow in Fourier Network (FN) for supported PINN neural operators, according to certain aspects of the present disclosure.

FIG. 8 schematically illustrates an example long short-term memory (LSTM) dataflow in Deep Galerkin Method (DGM) Network for supported PINN neural operators, according to certain aspects of the present disclosure.

FIG. 9 schematically illustrates input mesh data compression module (IDCM) technique for both FEM and PINN in, for example, the PhyCU of FIG. 1, according to certain aspects of the present disclosure.

FIG. 10 is a chart illustrating input data (KB) versus data reduction of PINN and FEM, according to certain aspects of the present disclosure.

FIG. 11 is a chart illustrating power (mW) versus power savings of PINN Layer 1 and FEM integral, according to certain aspects of the present disclosure.

FIG. 12 schematically illustrates implementation details of FEM mode computing sequence which can be performed in, for example, the PhyCU of FIG. 1, according to certain aspects of the present disclosure.

FIG. 13 schematically illustrates a programmable triple integral, depicted in FIG. 12, performed by a programmable polynomial in, for example, the PHY-E of the PhyCU of FIG. 1, according to certain aspects of the present disclosure.

FIG. 14 schematically illustrates an iterative conjugate gradient (CG) method depicted in FIG. 12, according to certain aspects of the present disclosure.

FIG. 15 schematically illustrates an index-free sparse matrix compression technique using Offset-Based Sparsity Adders Scheduler (OBSAS) for sparse matrix-vector (SpMv) in the CG method depicted in FIG. 14, according to certain aspects of the present disclosure.

FIG. 16 is a chart illustrating data reduction for top general purpose (TGP) SRAM by data size versus number of elements in No OBSAS and +OBSAS, according to certain aspects of the present disclosure.

FIG. 17 is a chart illustrating CG speedup with OBSAS by number of cycles versus number of elements in No OBSAS and +OBSAS, according to certain aspects of the present disclosure.

FIG. 18 is a chart illustrating efficiency (TOPS/W) versus Voltage (V) for FEM and PINN, according to certain aspects of the present disclosure.

FIG. 19 is a chart illustrating latency (μs) for PhyCU FEM and PhyCU PINN, according to certain aspects of the present disclosure.

FIG. 20 is a chart illustrating energy (μJ) for PhyCU FEM and PhyCU PINN, according to certain aspects of the present disclosure.

FIG. 21 is a chart illustrating frequency (MHz) versus voltage (V) for PhyCU FEM and PhyCU PINN, according to certain aspects of the present disclosure.

FIG. 22 is a chart illustrating power (mW) versus voltage (V) for PhyCU FEM and PhyCU PINN, according to certain aspects of the present disclosure.

FIG. 23 illustrates a die micrograph the PhyCU of FIG. 1, according to certain aspects of the present disclosure.

FIG. 24 is table illustrating specification details of the PhyCU of FIG. 1, according to certain aspects of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

To overcome conventional challenges, the disclosed technology provides an architecture 100 of an unified physics computing unit (PhyCU) 10 supporting both physics-informed neural network (PINN) mode 12 solutions, via a PINN accumulator 14, and finite element method (FEM) mode 16 solutions, via a FEM accumulator 18. Certain advantages of the PhyCU 10 are as follows: 1) the disclosed technology delivers an application-specific integrated circuit (ASIC) solution supporting inference for most major PINN models with configurable dataflow; 2) The PhyCU 10 architecture 100 also natively supports the FEM mode 16 through a conjugate gradient (CG) iterative method 20 providing a high-accuracy alternative using the same hardware; 3) Sparsity and data compression techniques for both PINN modes 12 and FEM mode 16 computation are developed achieving orders of magnitude latency reduction compared with a solution on GPU and 19.5-35.9× energy savings compared with prior ASICs.

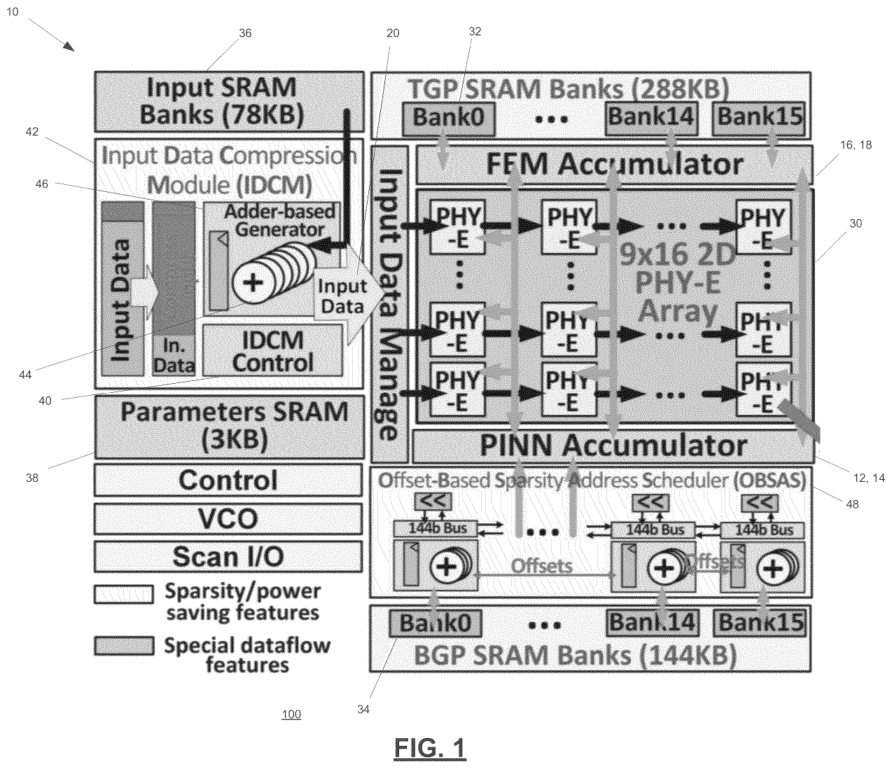

With reference to FIGS. 1-4, the PhyCU 10 architecture 100 supporting both the PINN modes 12 solution for low latency and the FEM mode 16 solution for high accuracy is depicted. For example, the PINN modes 12 take coordinates and time steps as input data 22 for a neural network (NN) 24 of a NN model (e.g., the PINN modes 12) and generates the physical status 26 for each mesh node 28, e.g., fluid velocity, vertical velocity, horizontal velocity, pressure, temperature. As a PINN's loss function is confined by underlining physics principles, boundary conditions and initial conditions, PINN modes 12 offer smaller and more accurate models compared with a plain NN. In certain aspects, the PhyCU 10 is utilized in an edge device.

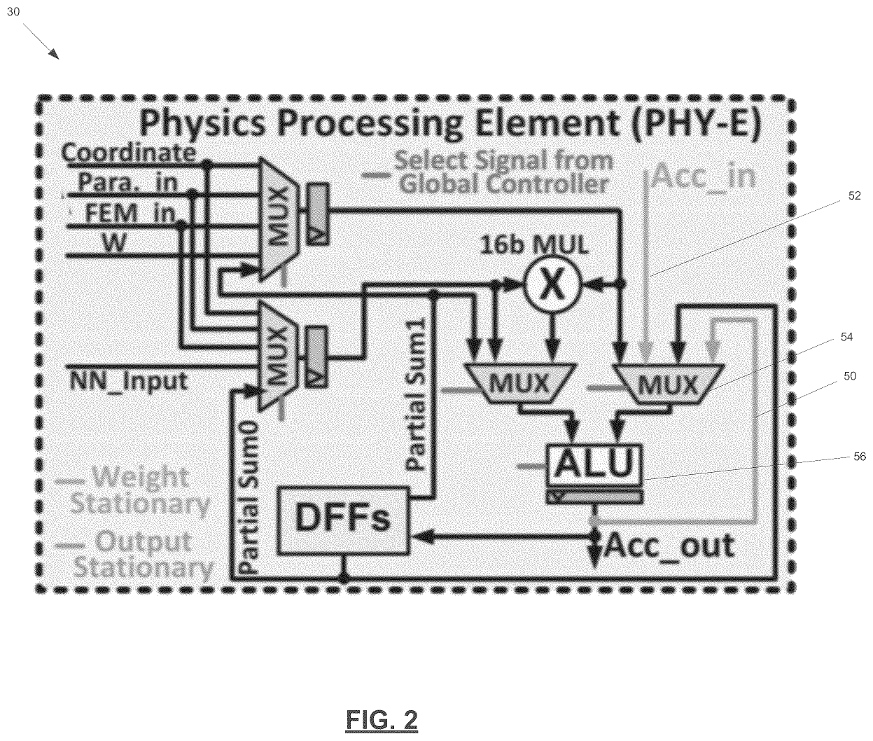

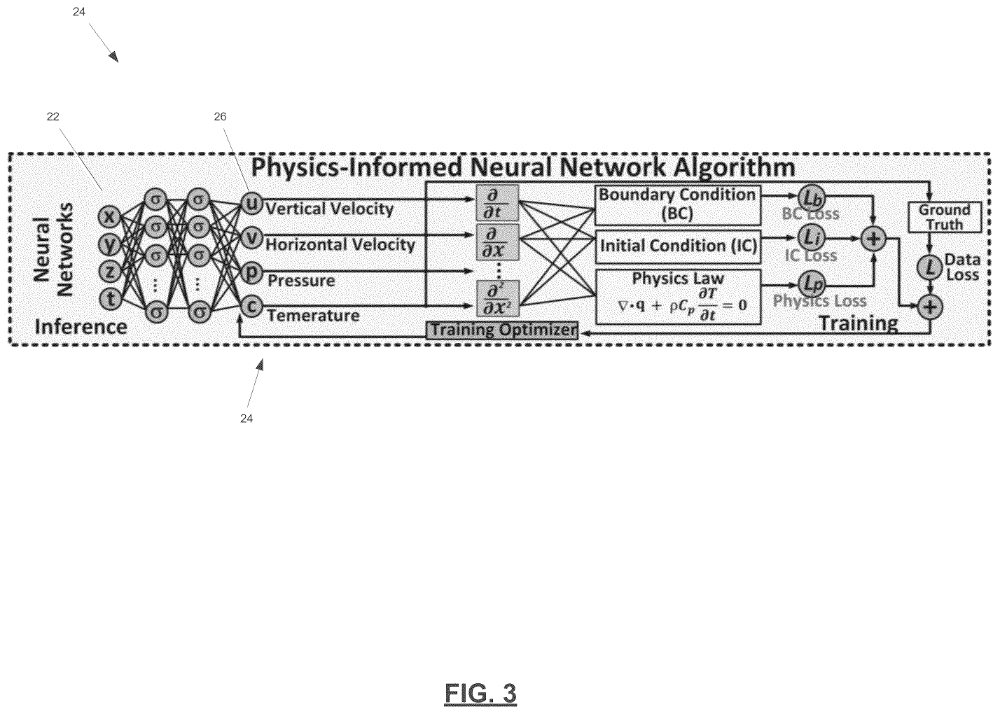

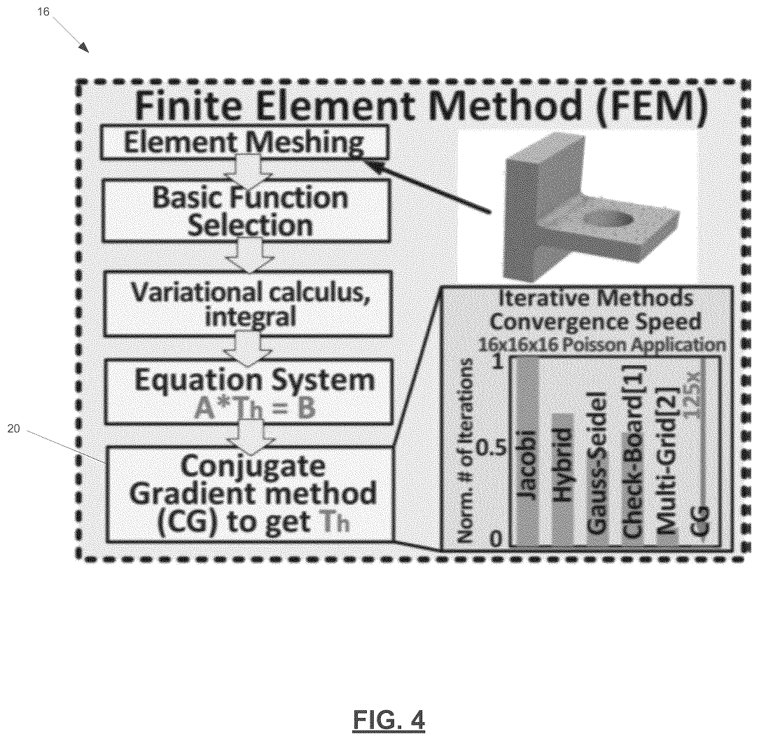

As for the FEM algorithm (e.g., the FEM mode 16) depicted in FIG. 4, after meshing the object with selected element shape, basic functions in cooperation with variational calculus and integrals are used to generate a symmetrical equation system. The CG iterative method 20 is the selected numerical method of the PhyCU 10 in FEM mode 16 due to its high convergence efficiency for complicated systems, e.g., 125× fewer iterations than some other iterative methods from prior works, and its high compatibility with the PINN architecture (e.g., the PINN modes 12) due to the use of matrix multiplication. As shown in FIG. 1, the architecture 100 of the PhyCU 10 contains a 9×16, for example, 2D physics processing elements (PHY-E) array 30 with top general purpose (TGP) SRAM banks 32, bottom general purpose (BGP) SRAM banks 34, input SRAM banks 36 and a special parameters SRAM bank 38 for special parameters. An Input Mesh Data Compression Module (IDCM) control 40 of an IDCM 42 of the PhyCU 10 is configured to compress coordinates (e.g., the input data 22) with simple adders 44 generated from an adder-based generator 46 and control logic by utilizing the physics meshing characteristics for both the PINN modes 12 and the FEM mode 16. An Offset-Based Sparsity Adders Scheduler (OBSAS) 48 of the PhyCU 10 is designed to improve sparse matrix-vector (SpMV) multiplication in the CG iterative method 20 of the FEM mode 16 and the PINN modes 12. Each PHY-E of the PHY-E array 30 supports output stationary NN dataflows 50 and weight stationary NN dataflow 52, with a multiplier 54 and an arithmetic logic unit (ALU) 56 for various numerical operations in the FEM mode 16 and the PINN modes 12, as depicted in FIG. 2. Each PHY-E of the PHY-E array 30 supports 8b, 16b, 32b precision for latency and accuracy tradeoff. For example, in certain aspects, each PHY-E of the PHY-E array 30 supports 8b and 16b for the PINN modes 12 and supports 16b and 32b for the FEM mode 16.

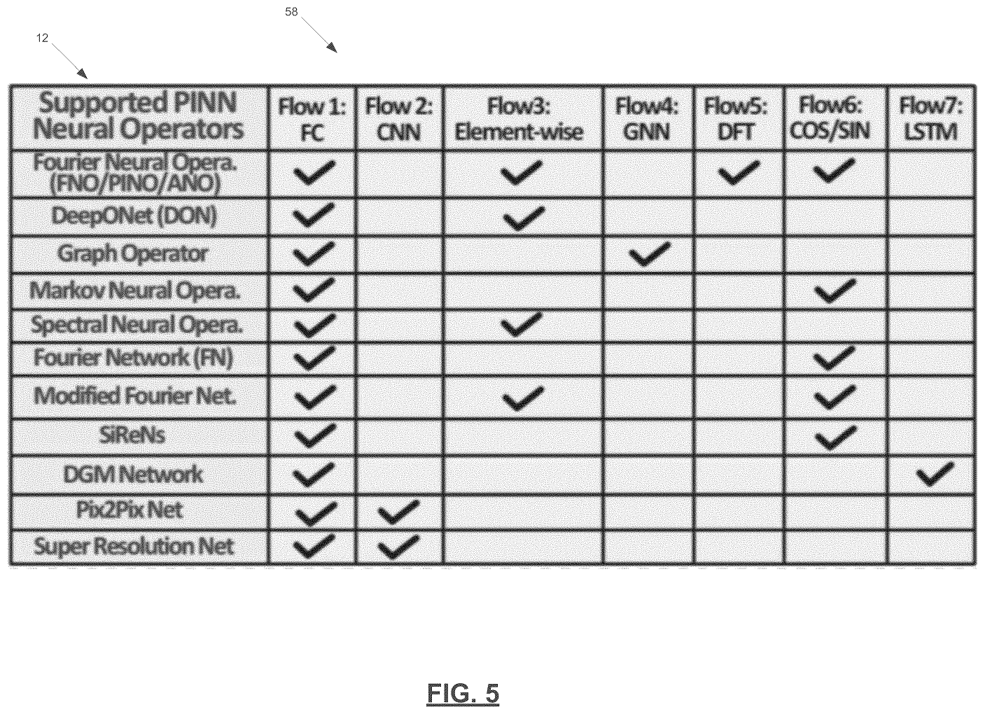

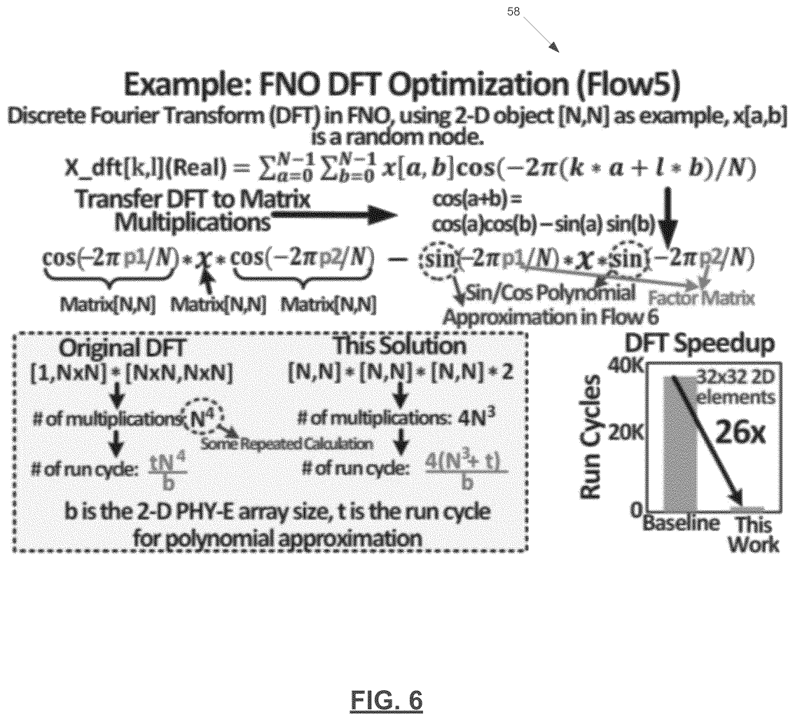

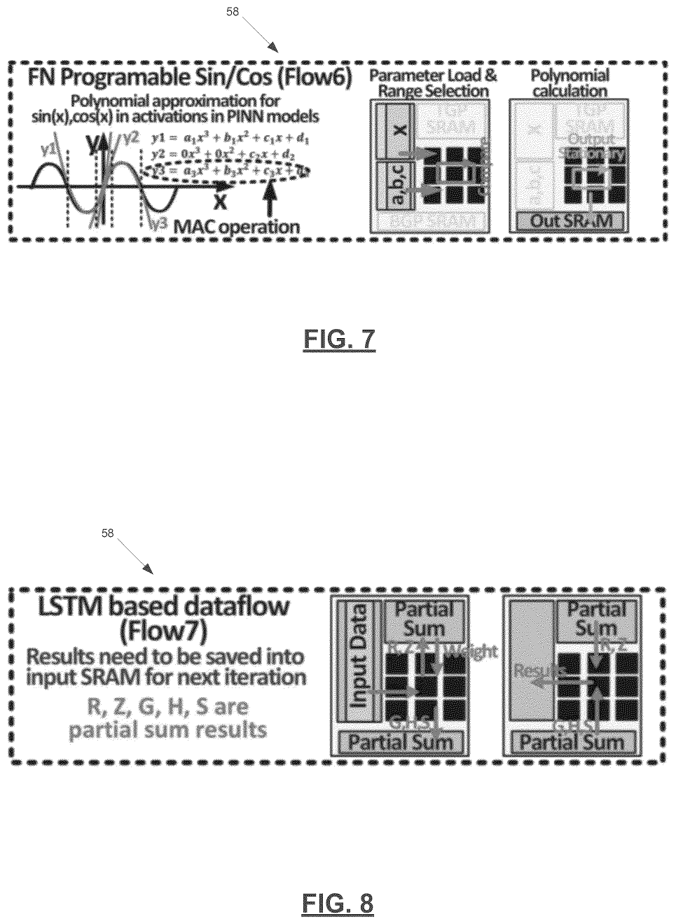

FIG. 5 shows the supported highly diversified PINN inference models (e.g., the PINN modes 12) with 7 exemplarily dedicated dataflows 58 (e.g., Flow 1: fully connected (FC), Flow 2: convolutional NN (CNN), Flow 3: Element-wise, Flow 4: graph neural network (GNN), Flow 5: DFT, Flow 6: COS/SIN, Flow 7: LSTM). Except the common NN dataflows of the dedicated dataflows 58, such as fully connected (FC) and convolutional NN (CNN), many of the PINN modes 12 need cos/sin activations such as Fourier Network (FN), SiReNs, etc. To realize cos/sin (e.g., Flow 6: COS/SIN) in the integer domain, polynomial approximation is implemented in the PhyCU 10 by approximating cos/sin functions as piecewise functions with the PHY-E array 30 used for range selection and MAC operations, as depicted in FIG. 7. As an example depicted in FIG. 6, another specially built dataflow of the dedicated dataflows 58 is for the Discrete Fourier Transform (DFT) (e.g., Flow 5: DFT) of the Fourier Neural Operator (FNO) of the PINN modes 12. Mathematical transformation with trigonometric function is used to replace DFT with matrix multiplications with a small matrix size by eliminating the repeated calculations in the original DFT, which provides a 26× run cycle saving for an application with a 32×32 elements mesh. As another example depicted in FIG. 8, for the dataflow of the dedicated dataflows 58 in the Deep Galerkin Method (DGM) network of the PINN modes 12, which is similar to LSTM of the dedicated dataflows 58 (e.g., Flow 7: LSTM), the PhyCU 10 reuses input SRAM from the input SRAM banks 34 as the final output SRAM avoiding the data transfer for later iterations in the DGM network.

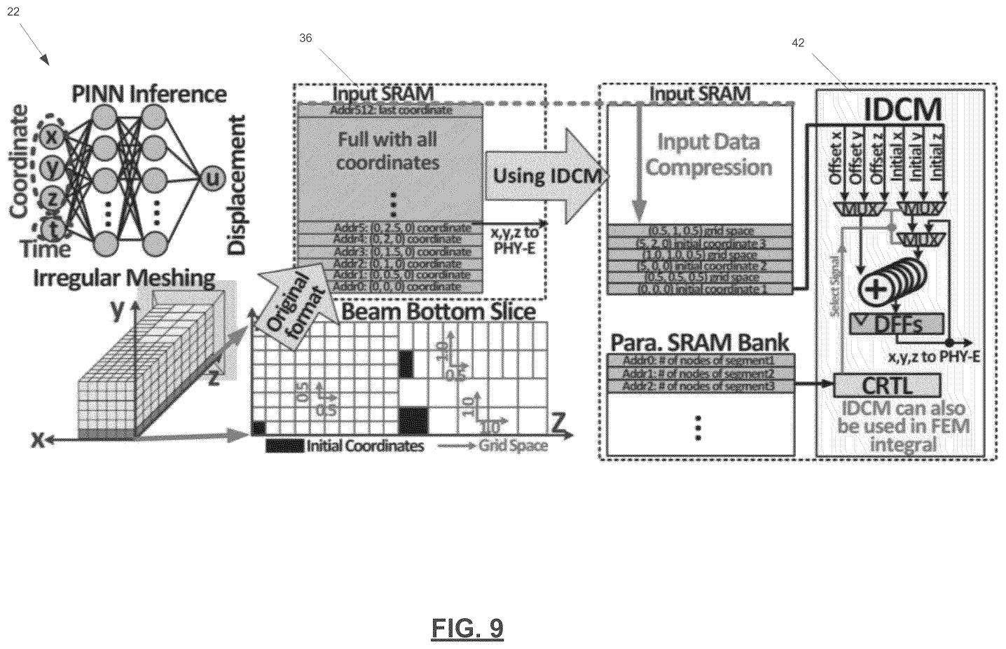

FIG. 9 schematically illustrates the details of the input mesh data compression module (IDCM) 42 operation via the IDCM control 40 used in the disclosed technology. Different elements have the same space within a specific segment as in the example of the bottom slice from a beam mesh. For each segment with the same grid space, only initial coordinate and grid space numbers need to be stored in the input SRAM banks 36. IDCM 42 utilizes adder chains to accumulate space numbers from the initial coordinates for generating a complete input dataset automatically, eliminating the coordinate information for the segments of the object. By implementing IDCM 42, input data size is reduced by 74% for the PINN modes 12 and 81% for the FEM mode 16 for a 3D sink heat-transfer analysis. By gating the input SRAM banks 36 during computing using the compressed data from IDCM 42, a 27-32% power saving is achieved for the first layer inference of the PINN modes 12 or the FEM mode 16 integral operation.

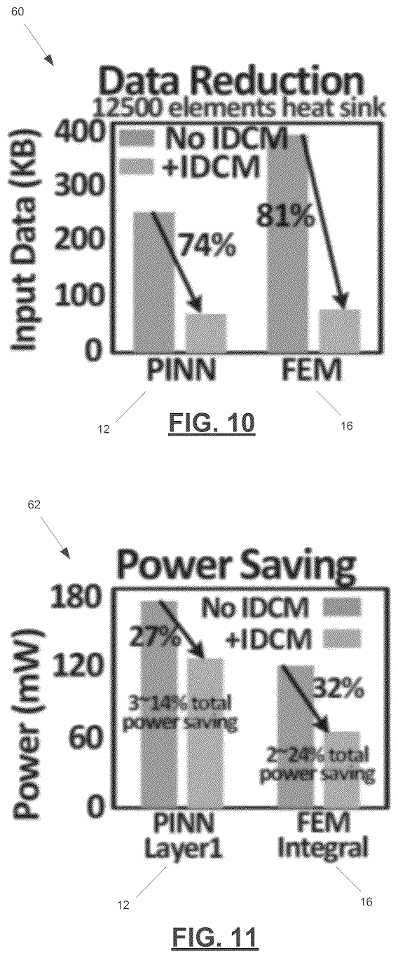

FIG. 10 is a first chart 60 illustrating input data (KB) versus data reduction of the PINN modes 12 and the FEM mode 16.

FIG. 11 is a second chart 62 illustrating power (mW) versus power savings of the PINN modes 12 Layer 1 and the FEM mode 16 integral.

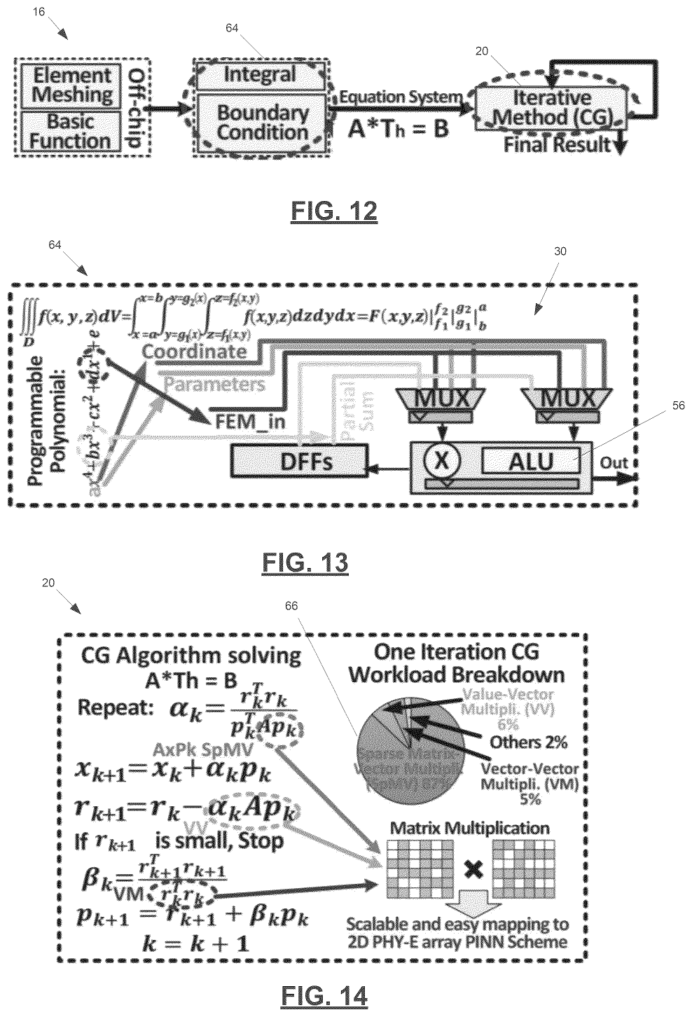

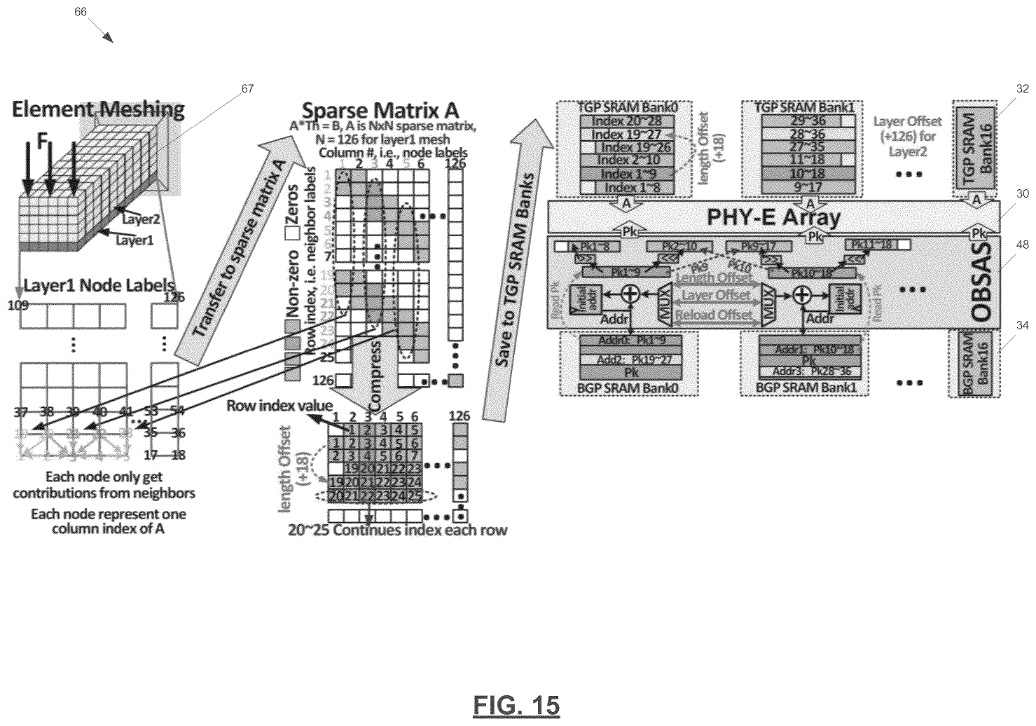

FIG. 12 schematically illustrates details and optimizations for the FEM mode 16 of the PhyCU 10 for a programmable triple integral 64 in the PHY-E array 30 and for the CG iterative method 20. With reference to FIG. 13, the PHY-E array 30 transfers the triple integral 64 of 3D objects and structures to MAC and ALU operations via the ALU 56 with coordinates from IDCM 42 as input. With reference to FIG. 14, among the three major operations in the CG algorithm (e.g., the CG iterative method 20), sparse matrix-vector (SpMV) 66 takes 87% of CG (e.g., the CG iterative method 20) workload in each iteration. To optimize SpMV 66, as schematically depicted in FIG. 15, the OBSAS 48 is implemented exploiting the sparsity of the coefficient matrix of the equation system (matrix A) which is the integral result. In the FEM mode 16, each node of mesh only interacts with its neighbor nodes. Hence, the non-zero values of matrix A are only located along the diagonal groups with three consecutive elements, as in the beam mesh 67 example shown in FIG. 15. Utilizing fixed offsets, e.g. length offset, layer offset on sparse matrix A and the reload offset from PHY-E array 30 size, a significant compression is achieved leveraging the repetitive pattern of meshing. As depicted in FIG. 15, the indices of each row of compressed matrix A are continuous and can be generated by shifting the indices from other rows in the same group. By utilizing self-accumulating adders and 3 offsets above, the OBSAS 48 can generate the required address for the parameter vector Pk for SpMV 66 of A*Pk in CG (e.g., the CG iterative method 20) without any index record of the compressed matrix A. Pk can be directly sent to the PHY-E array 30 to be multiplied by a group of compressed matrix A after generating all Pk values by 2 shifters in the OBSAS 48. The compression through the OBSAS 48 leads to a 460× CG speedup on a 3D 12500-element heat-sink application with the FEM mode 16.

FIG. 16 illustrates a third chart 68 illustrating data reduction for the top general purpose (TGP) SRAM 32 by data size versus number of elements in No OBSAS (e.g., no OBSAS 48) and +OBSAS (e.g., +OBSAS 48.

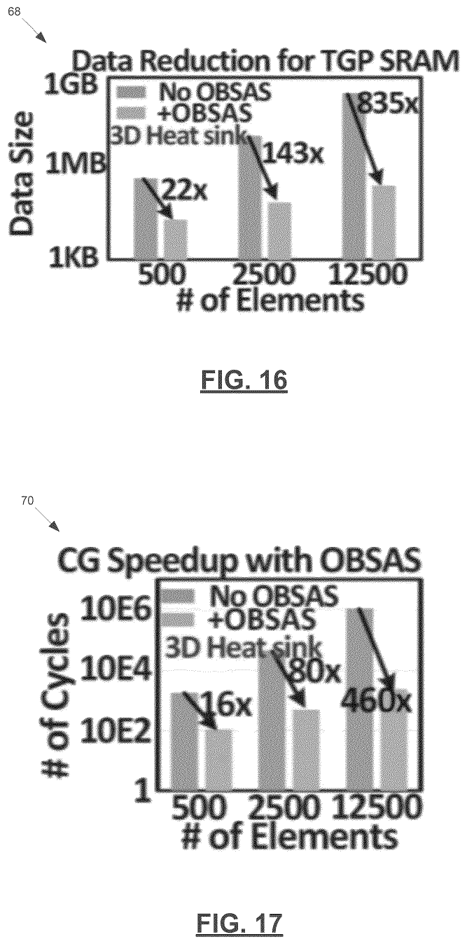

FIG. 17 illustrates a fourth chart 70 illustrating CG speedup with the OBSAS 48 by number of cycles versus number of elements in No OBSAS (e.g., no OBSAS 48) and +OBSAS (e.g., +OBSAS 48.

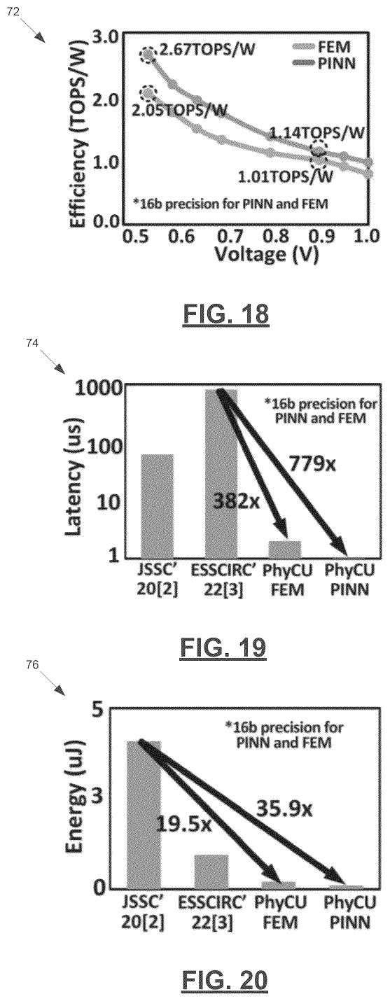

FIG. 18 illustrates a fifth chart 72 illustrating efficiency (TOPS/W) versus Voltage (V) for the FEM mode 16 and the PINN modes 12 with a supply voltage scaling from 0.9V to 0.55V.

FIG. 19 illustrates a sixth chart 74 illustrating latency (μs) for PhyCU FEM (e.g., the FEM mode 16) and PhyCU PINN (e.g., the PINN modes 12).

FIG. 20 illustrates a seventh chart 76 illustrating energy (μJ) for PhyCU FEM (e.g., the FEM mode 16) and PhyCU PINN (e.g., the PINN modes 12). A 1.14-to-2.67 TOPS/W energy efficiency and a 1.01-to-2.05 TOPS/W energy efficiency are achieved for 16b PINN (e.g., the PINN modes 12) and 16b FEM (e.g., the FEM mode 16), respectively.

FIG. 21 illustrates an eighth chart 78 illustrating frequency (MHz) versus voltage (V) for PhyCU FEM (e.g., the FEM mode 16) and PhyCU PINN (e.g., the PINN modes 12).

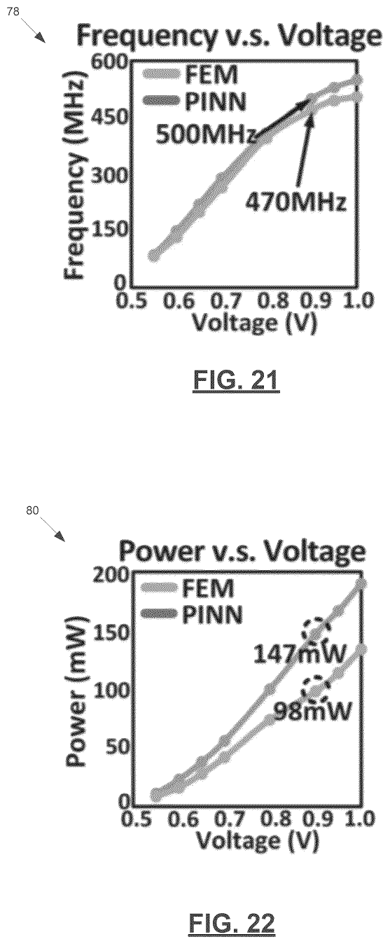

FIG. 22 illustrates a ninth chart 80 illustrating power (mW) versus voltage (V) for PhyCU FEM (e.g., the FEM mode 16) and PhyCU PINN (e.g., the PINN modes 12.

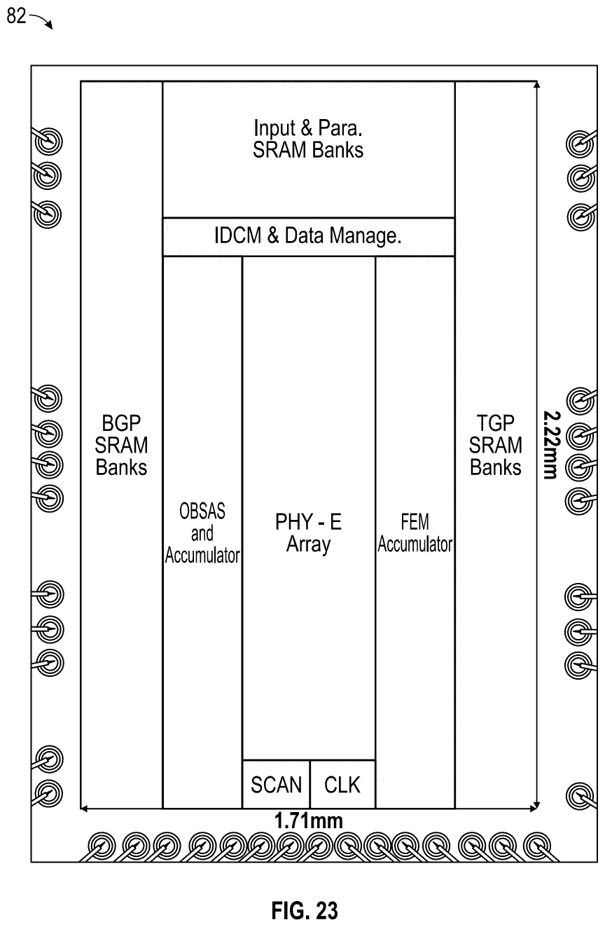

FIG. 23 illustrates a die micrograph 82 of the PhyCU 10. In certain aspects, the PhyCU 10 is 28 nm. FIG. 5 shows three detailed real-time test cases.

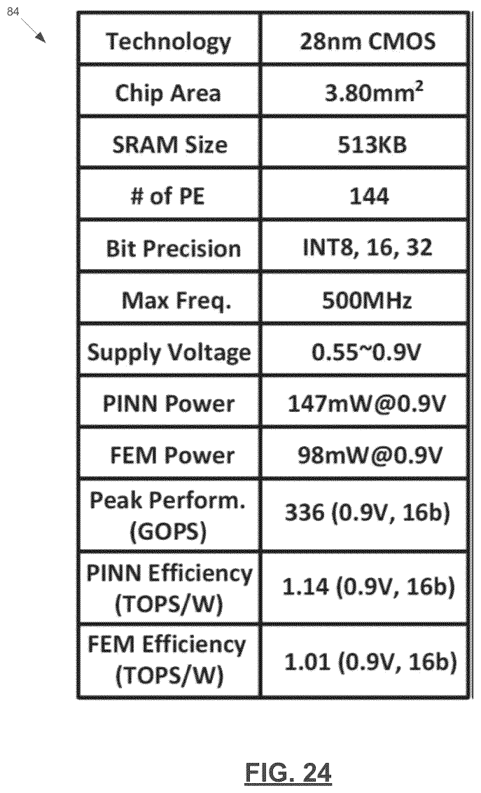

FIG. 24 illustrates a table 84 illustrating specification details of the PhyCU 10.

In a first example, a beam deformation caused from a hand push uses the dynamic equilibrium equation in a VR/MR environment with a 25 fps requirement. The PhyCU 10 finishes the deformation analysis in only 8 ms by using a GNN-based (e.g., Flow 4: GNN) PINN operator vs. 9 s on RTX3080 GPU using conventional solver rendering a 1125× speedup with a 1.9% accuracy degradation. In a second example, a fluid pressure analysis with an aneurysm is used during medical imaging. The PhyCU 10 finishes the analysis in 22 ms achieving 2590× speedup vs. conventional solvers on GPU with 2.6% accuracy loss. In a third example, thermodynamics and fluid dynamics are combined for heat-transfer and fluid-velocity analysis. The PhyCU 10 finishes the analysis in 40 ms with 1839× speedup over GPU and 3.39% accuracy loss. In certain aspects, the PINN modes 12 in the PhyCU 10 achieves 434-to-2457× speedup over GPU with 1-to-5.7% (average 2.4%) accuracy loss.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A physics computing unit (PhyCU) on an application-specific integrated circuit (ASIC), comprising:
a physics processing element (PHY-E) array;
top general purpose SRAM banks in communication with the PHY-E array;
bottom general purpose SRAM banks in communication with the PHY-E array;
input SRAM banks in communication with the PHY-E array, wherein the input SRAM banks are configured to store input data;
a special parameters SRAM BANK in communication with the PHY-E array;
an input mesh data compression module (IDCM) in communication with the input SRAM banks and the PHY-E array, wherein the PHY-E is reconfigurable to operate in a physics-informed neural network (PINN) modes and a finite element method (FEM) mode; and
an offset-based sparsity address scheduler (OBSAS) configured to compress the input data for sparse matrix-vector (SpMV) multiplication in the PINN modes and for conjugate gradient (CG) iterative method in the FEM mode.

2. The PhyCU of claim 1, wherein the PHY-E array is configured to support output stationary neural network (NN) dataflows and weight stationary NN dataflow.

3. The PhyCU of claim 2, wherein the PHY-E array supports 16b and 32b for the FEM mode.

4. The PhyCU of claim 2, wherein the PHY-E array supports 8b and 16b for the PINN modes.

5. The PhyCU of claim 1, wherein the PHY-E array is a 9×16 2D PHY-E array.

6. The PhyCU of claim 1, wherein the ASIC is 28 nm.

7. The PhyCU of claim 1, wherein the input data comprises coordinates and time steps.

8. The PhyCU of claim 1, wherein the PHY-E array is configured to support, in the PINN modes, dedicated dataflows comprising one of fully connected (FC) dataflow, convolutional neural network (CNN) dataflow, Element-wise dataflow, graph neural network (GNN) dataflow, Discrete Fourier Transform (DFT) dataflow, COS/SIN dataflow, and long short-term memory (LSTM) dataflow.

9. The PhyCU of claim 8, wherein, in the LSTM dataflow, the input SRAM banks are reused as a final output SRAM.

10. The PhyCU of claim 1, wherein the input SRAM banks are gated during computing operations by using compressed data from the IDCM.

11. An edge device, comprising:
at least one physics computing unit (PhyCU) on an application-specific integrated circuit (ASIC), the PhyCU comprising:
a physics processing element (PHY-E) array;
top general purpose SRAM banks in communication with the PHY-E array;
bottom general purpose SRAM banks in communication with the PHY-E array;
input SRAM banks in communication with the PHY-E array, wherein the input SRAM banks are configured to store input data;
a special parameters SRAM bank in communication with the PHY-E array;
an input mesh data compression module (IDCM) in communication with the input SRAM banks and the PHY-E array, wherein the PHY-E is reconfigurable to operate in a physics-informed neural network (PINN) modes and a finite element method (FEM) mode; and
an offset-based sparsity address scheduler (OBSAS) configured to compress the input data for sparse matrix-vector (SpMV) multiplication in the PINN modes and for conjugate gradient (CG) iterative method in the FEM mode.

12. The edge device of claim 11, wherein the PHY-E array is configured to support output stationary neural network (NN) dataflows and weight stationary NN dataflow.

13. The edge device of claim 12, wherein the PHY-E array supports 16b and 32b for the FEM mode.

14. The edge device of claim 12, wherein the PHY-E array supports 8b and 16b for the PINN modes.

15. The edge device of claim 11, wherein the PHY-E array is a 9×16 2D PHY-E array.

16. The edge device of claim 11, wherein the ASIC is 28 nm.

17. The edge device of claim 11, wherein the input data comprises coordinates and time steps.

18. The edge device of claim 11, wherein the PHY-E array is configured to support, in the PINN modes, dedicated dataflows comprising one of fully connected (FC) dataflow, convolutional neural network (CNN) dataflow, Element-wise dataflow, graph neural network (GNN) dataflow, Discrete Fourier Transform (DFT) dataflow, COS/SIN dataflow, and long short-term memory (LSTM) dataflow.

19. The edge device of claim 18, wherein, in the LSTM dataflow, the input SRAM banks are reused as a final output SRAM.

20. The edge device of claim 11, wherein the input SRAM banks are gated during computing operations by using compressed data from the IDCM.
